(19) United States
(12) Patent Application Publication
(10) Pub. No.: US 2004/0234703 A1
(43) Pub. Date: Nov. 25, 2004

(54) Method of forming a polymer layer on a metal surface

(76) Inventor: Jack R. Frautschi, Athens, TX (US)

Correspondence Address: Kenneth M Bush, Bush Intellectual Property Law Group, PO Box 381146, Birmingham, AL, 35238, US

(21) Appl. No.: 10/473,648

(22) PCT Filed: Jun. 4, 2003
(86) PCT No.: PCT/US03/17603

Related U.S. Application Data
(60) Provisional application No. 60/385,699, filed on Jun. 4, 2002.

(51) Int. Cl. H05H 1/00; B05D 3/00

(52) U.S. Cl. 427/535; 427/299

(57) ABSTRACT

A method of forming a polymer tie layer on a metal surface by cleaning the metal surface with solvent; cleaning the metal surface with oxygen plasma; sputter cleaning the metal surface with argon using a lower chuck bias plasma generating unit; functionalizing the metal surface; and depositing the tie layer on the metal surface by radio frequency plasma deposition under pulsed conditions of a duty cycle, where the duty cycle is reduced over time. This method produces a tie layer chemically bound to the metal surface. The tie layer, thus, has high bonding strength to the metal and high elasticity, making it very resistant to cracks, scratches, delamination, and wicking. The tie layer can have functional groups on its surface for the chemical attachment of a second coating, or can act on its own by providing lubricity or blood compatibility, or both to the underlying metal.

This application claims the benefit of U.S. Provisional Application Ser. No. 60/385,699 filed on Jun. 4, 2002, titled “Using Plasma Deposition to Improve Medical Device Function” and U.S. Provisional Application Ser. No. 60/446,781 filed on Feb. 12, 2003, titled “Method for Forming Polymer Tie Layer on Metal Surface”, which are incorporated herein by reference.

### TECHNICAL FIELD

The present invention relates to the field of plasma deposition of organic films on substrates and, more particularly, to a method for the deposition of an organic film tie layer on a metal surface using radio frequency plasma deposition.

### BACKGROUND ART

Plasma deposition has been used to create a very tight adhesion, via a chemical bond, between the deposited film and a nonmetal polymer substrate, particularly for medical application. Currently, this process allows nonmetal substrates to be coated without exposing them to solvents, high temperatures, or radiation. Films deposited by this technique display many desirable characteristics including ease of preparation, coating uniformity, conformal coverage of complex substrates, and the ability to generate unique chemistries. The deposited films generally do not penetrate into the substrate and therefore do not significantly change the mechanical properties from that of the unmodified substrate. The films are usually free of leachable components and can be designed to prevent leachable components in the substrate from diffusing out. Plasma deposition of film on metal substrate has not been as successful as with nonmetal substrates.

Known methods of plasma deposition of a film on a metal substrate involve applying a hydrocarbon residue undercoat to a metal substrate by plasma deposition. A photoactive hydrophilic polymer is then deposited on the hydrocarbon residue coating and activated by ultraviolet light. The hydrocarbon residue coating acts as a tie layer between the hydrophilic polymer and the metal substrate by providing C—C bonds (carbon-carbon single bond) for the covalent linking of the hydrophilic polymer to the tie layer. Another approach that has been used has been to apply fluorinated coatings such as teflon on metal substrates. These present methods provide coatings on metal surfaces that are excessively thick, have relatively low adhesion and elasticity, and can crack under stress. In addition, when such coatings are scratched fluids can penetrate through the film to the interface of the film and the metal, producing film delamination.

### DISCLOSURE OF INVENTION

The present invention provides a process for coating substrates, including metals, with a tie layer. The tie layer can have functional groups on its surface for the chemical attachment of a second coating, or can act on its own by providing lubricity or blood compatibility, or both to the underlying metal. The tie layer is believed to be covalently bound to the metal surface and can provide C═C bonds (carbon-carbon double bonds) for the covalent attachment of another film having any desired properties. The metal substrate is first cleaned with solvent, then cleaned with oxygen plasma, and then sputter cleaned with argon plasma. Chemically reactive intermediates are then bonded to the metal substrate surface to create a direct chemical binding between the metal surface and the polymer tie layer, using a plasma gas such as oxygen, followed by a gas such as butadiene to produce a polymer tie layer with C═C bonds. Polymer deposition can be produced under pulsed conditions using a duty cycle where the duty cycle is reduced over time. These steps allow the film on the substrate surface to transition from a more rigid highly adhesive hydrocarbon to an elastic polymer similar to a naturally polymerized polymer. This transition in film properties increases the mechanical strength of the polymer film by reducing the occurrence of stress risers within the film, when placed under mechanical loads or stresses.

An advantage of the present invention is a simple plasma deposition method for producing a tightly bound, strong, elastic polymer film on a metal substrate.

Another advantage of the present invention is a method for producing a polymer tie layer on a metal surface which is chemically bound to the metal surface and which provides one or more C═C bonds or one or more C≡C bonds for covalent attachment of a second polymer film having any desired properties.

Another advantage of the present invention is a method of sputter cleaning a metal surface to remove loosely adherent metal oxide and facilitate functionalization of the metal surface.

Another advantage of the present invention is a method of polymer deposition under pulsed conditions using a duty cycle, where the duty cycle is reduced over time, and the off time is minimized and kept constant to keep the plasma lit at low plasma powers.

Another advantage of the present invention is the use of a plasma system composed of two separate plasma generating units comprising a top coil and a bottom biased chuck, the chuck being used for sputtering and to enhance deposition during plasma generation by the top coil.

Another advantage of the present invention is a method for producing polymer films on a metal surface which provide a variety of surface properties, including lubricious and/or blood compatible properties.

### BRIEF DESCRIPTION OF DRAWINGS

FIG. 1 shows a diagram of the steps of the method of the present invention.

FIG. 2 shows a diagram of the chemical conformation of the polybutadiene tie layer.

FIG. 3 shows a graph of the surface chemistry of the butadiene tie layer confirming the presence of C═C bonds in the tie layer.

FIG. 4 shows pictures obtained under optical microscopy of coated metal surfaces bent 90° and soaked.

FIG. 5 shows pictures obtained under scanning electron microscopy of coated metal surfaces flexed and soaked.

FIG. 6 shows pictures obtained under scanning electron microscopy of a coated metal surface containing a 25 μm-wide scratch.

FIG. 7 shows pictures obtained under scanning electron microscopy of a coated metal surface containing a 50 μm-wide scratch.

### BEST MODE FOR CARRYING OUT THE INVENTION

While the following description details the preferred embodiments of the present invention, it is to be understood that the invention is not limited in its application to the details of construction and arrangement of the parts illustrated in the accompanying drawings, since the invention is capable of other embodiments and of being practiced in various ways.

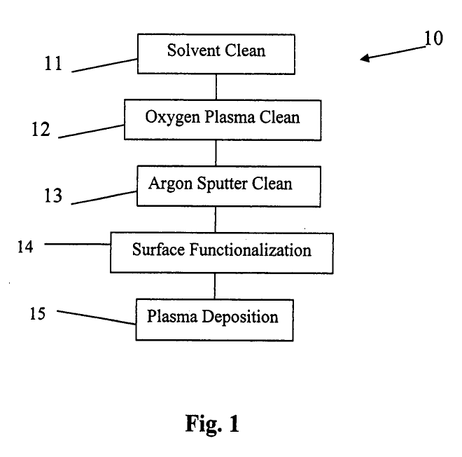

FIG. 1 shows the method 10 of the present invention used to create a very adherent tie layer to a metal surface. The plasma system consisted of two separate plasma generating units, a high density plasma source system (upper coil) and a lower chuck bias power source system, each having a power source at a radiofrequency (RF) of 13.56 kHz. The chuck is used for sputtering and to enhance deposition during plasma generation by the top coil. Both of the plasma generators contained an impedance matching network to tune the plasma. In step 11 the metal surface is cleaned with solvent to remove surface contaminants. In step 12 the metal surface is cleaned with plasma oxygen to remove remaining contaminants. In step 13 the metal surface is argon sputter cleaned to remove loosely adherent oxidized metal and thus promote bonding to the native metal. The alternating e-field of the lower chuck is perpendicular to the lower chuck, attracting both positive and negative ions causing them to bombard the sample at a high energy. Depending on the thickness of the oxidized metal, it may be necessary to significantly increase either the sputter time or power to the lower chuck electrode. In step 14 the metal surface is functionalized. Chemically reactive intermediates are bonded to the metal to create a direct chemical binding between the metal and polymer coating. Oxygen is conveniently used to create oxides on the surface of the metal. However other gases such as NH₃, H₂O, CO₂, H₂O₂, etc. may be utilized to create functional groups, to enhance the binding strength of the metal-polymer bond. The functional groups created on a metal surface like NHₓ, OH, OOH, COₓ, O, etc. may allow the depositing polymer to form a chemical bond with the metal, which otherwise would not be formed, or to form a stronger more stable chemical bond with the metal. Step 15 is the polymer deposition of the butadiene polymer tie layer. Deposition occurs under pulsed conditions, where the duty cycle is reduced over time. Reducing the duty cycle decreases the average power of the plasma and its ability to break chemical bonds within the monomer gas. This allows increasingly more C═Cs to be incorporated into the film as the film progresses from the metal surface to the surface of the film. In the case of butadiene, the retention of some C═Cs (1660 cm-1, FTIR) enhances the elasticity of the polymer and also creates reactive sites for chemical attachment of a second coating. To facilitate retaining the plasma (keeping it lit) at very low powers, the off time of the pulse is kept at 40 milliseconds (ms). This is accomplished by increasing the pulse frequency as the duty cycle is reduced, consequently keeping the plasma off time to a minimum, so that the plasma will remain lit at very low average powers.

These steps allow the film on the surface of the metal to transition from a more rigid, adhesive hydrocarbon at the metal surface to an elastic polymer at the film surface, very similar to the naturally polymerized polymer. Therefore an elastic polymer of polybutadiene can be created on the tie layer surface, or a lubricious polymer can be created on the polymer tie surface if the feed gas is vinyl pyrrolidinone or acrylic acid or the like. This transition in film properties also increases the mechanical strength of the film by reducing the occurrence of stress risers (failure points) within the film, when placed under mechanical loads or stresses.

A leakage current (about 0.1 W) that is applied to the lower chuck bias electrode enhances the rate of deposition by causing a small attraction of charged polymer particles and other charged moieties. The leakage current is turned off during plasma deposition at very low RF source powers. The duty cycle may be modified to provide, for example: 1) thicker polymer films by increasing the time at each duty cycle, or 2) less elastic polymer films by not depositing at the low duty cycles. A quench with the monomeric depositing moiety (e.g. butadiene) allows any remaining reactive components like radicals to be removed from the film by reacting with gaseous unreacted monomer. This step creates a polymer film that changes very little chemically upon prolonged environmental exposure.

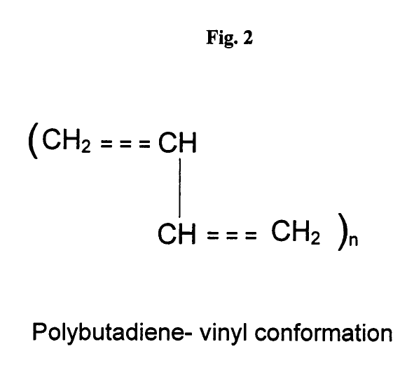

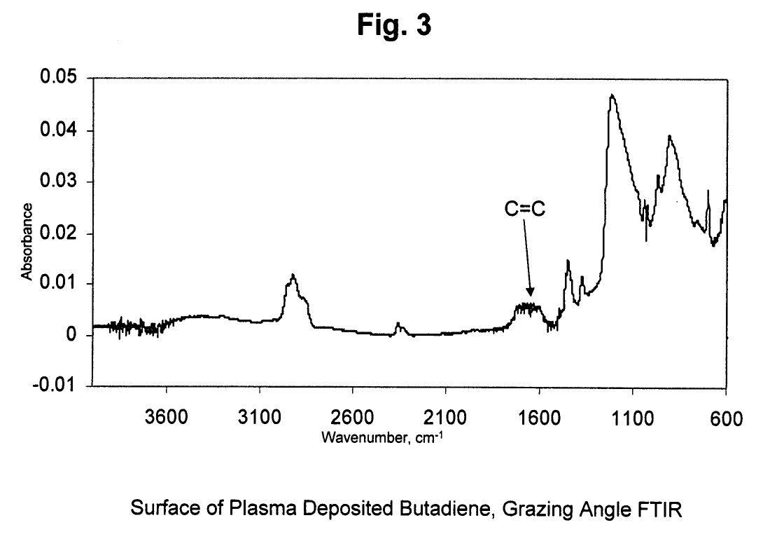

FIG. 2 shows the polybutadiene-vinyl conformation of the tie layer formed by the method of the present invention. Samples from tie layers created as detailed in FIG. 1 were analyzed with the Grazing Angle FTIR-ATR. The Grazing Angle FTIR-ATR provides 100× the chemical sensitivity when compared to standard FTIR-ATR, so the outermost monolayer can be sampled and recorded. Surface film chemistry is shown in the spectra presented in FIG. 3. The results demonstrated that there are indeed C═C bonds in the surface of the butadiene tie layer. The C═C bonds provide elasticity and also a reactive site for chemical attachment of a second coating. According to the published spectra of polybutadiene, there are three conformations (cis, trans and vinyl) in which polybutadiene may exist. The plasma deposited polybutadiene by the method of the present invention produces polymers composed of the vinyl conformation (>85%).

### EXAMPLE

A stainless steel wire was washed successively for 3 minutes with methylene chloride, isopropanol, and deionized water, and then air dried (step 11). The wire was then cleaned with plasma oxygen to remove remaining contaminants, using inductive plasma at 200 W, 50 mTorr, 20 sccm (standard cubic centimeters) O₂, 30 seconds (step 12). The wire was then argon sputter cleaned to remove loosely adherent oxidized metal and thus promote bonding of the tie layer to the native metal. Capacitive plasma was used with the lower chuck bias electrode at 60 W, 100 mTorr, 20 sccm argon, 60 seconds (step 13). Chemically reactive intermediates were then bonded to the wire to create a direct chemical binding between the metal and polymer tie coating followed by an argon quench: inductive plasma at 200 W, 50 mTorr, 20 sccm O₂, 3 minutes; and a 10 minute argon quench to cool the parts (step 14). A plasma deposition of a butadiene polymer tie layer was then performed. Argon was first removed (<5 mTorr) and then butadiene plasma was initiated: capacitive plasma at 60 W, 50 mTorr, 8 sccm butadiene, leakage current on lower electrode results in a power of approximately 0.1 W. The plasma pulsing mode/duty cycle used is shown in Table 1.

TABLE 1
Plasma Pulsing Mode/Duty Cycle

| | | | | | | | | | |
|---|---|---|---|---|---|---|---|---|---|
| Duty, | 100 | 87 | 75 | 63 | 50 | 37 | 25 | 13 | 3 |
| % | | | | | | | | | |
| Frequency, | NA | 3.3 | 6.35 | 9.39 | 12.69 | 15.74 | 19.03 | 22.08 | 24.62 |
| Hz | | | | | | | | | |
| Total Time | 30 | 46 | 51 | 62 | 86 | 98 | 116 | 149 | 168 |
| seconds | | | | | | | | | |

When the last cycle is completed the plasma is extinguished and the butadiene gas is allowed to flow for 5 minutes. Butadiene quenching allows any remaining reactive intermediates like radicals to react with butadiene molecules and thereby create a more chemically stable film (step 15).

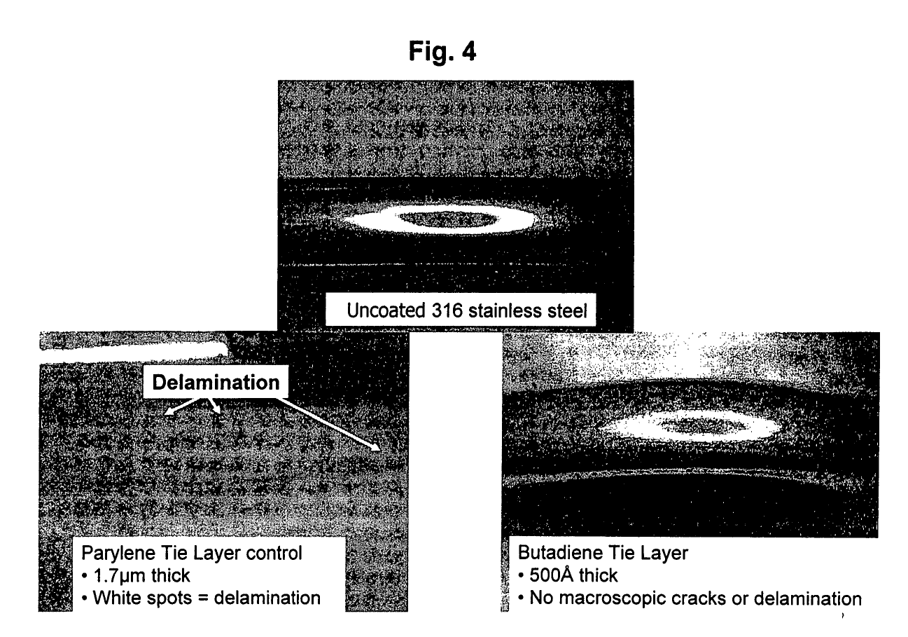

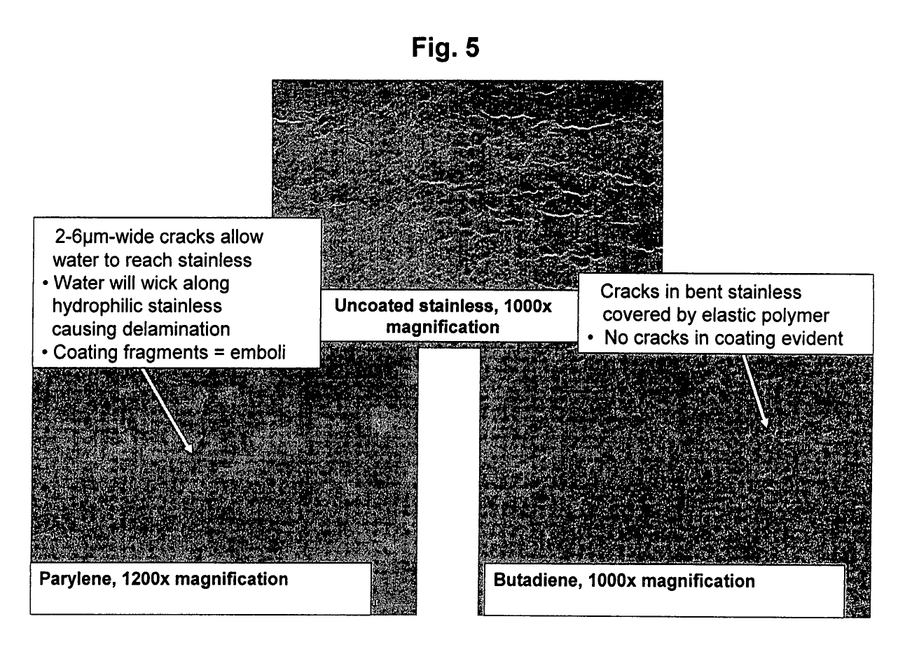

Stainless steel wire samples coated with butadiene polymer tie layer, as described in the above example, were tested for resistance to cracking and delamination during flexion, tape test (ASTM D3359-97) for coating adhesion, and solvent resistance. In flexion experiments the bent coated wire was straightened, is placed in 37° C. flowing water for 10 minutes, removed from the water and bent 90°, and placed back in the 37° C. flowing water for 20 hours. For comparision a stainless steel wire using a parylene tie layer was also studied. FIG. 4 shows the results of this test using optical microscopy (20× magnification). The sample with the butadiene tie layer had no macroscopic cracks or delamination, whereas the sample with the parylene tie layer showed delamination as indicated by the presence of white spots. FIG. 5 shows the results of this study using scanning electron microscopy. In the sample with the butadiene tie layer no cracks were evident in the surface film. In the sample with the parylene tie layer 2-6 μm-wide cracks were observed which could allow water to reach the metal surface. In such a case, water will wick along the metal surface causing delamination. If coating fragments were removed from the parylene tie layer the result would be emboli formation in the blood stream. Thus, the butadiene coating of the present invention would be expected to be safer for in vivo use compared to the parylene coating. The results show that the method of the present invention produces polymer coatings that are highly adhesive and highly elastic.

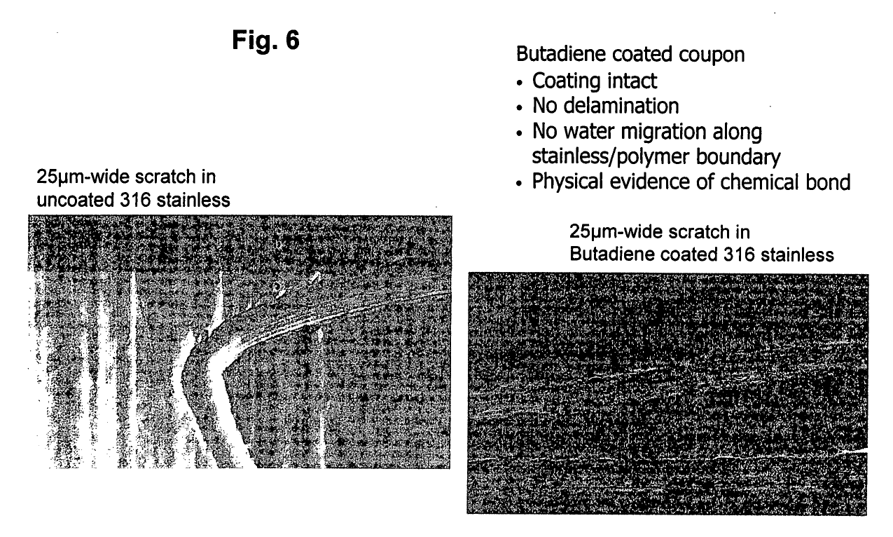

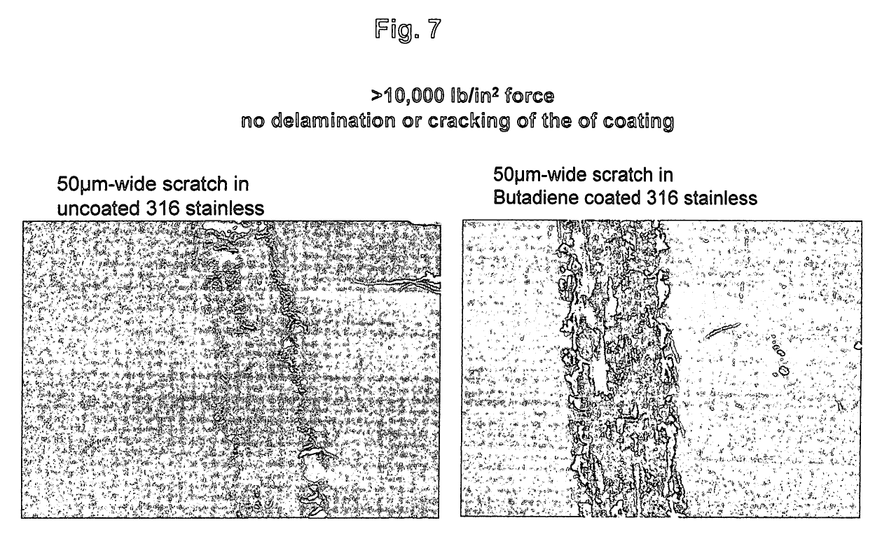

In scratch testing experiments a scratch was made on a flat piece of stainless steel, the scratch being representative of damage produced by a sharp surgical tool or by crystalline plaque in calcific blood vessels. The metal samples were bent 90°, incubated for 10 minutes in 37° C. flowing water, then bent 180° in the opposite direction, and placed in the 37° C. flowing water/saline for 20 hours. The samples were then evaluated by scanning electron microscopy (350× magnification). FIG. 6 shows the results of a 25 μm-wide scratch and FIG. 7 shows the results of a 50 μm-wide scratch. In both cases there was no cracking or delamination of the coating and no evidence of water migration along the metal/polymer boundary. These results provide physical evidence of chemical bonding of the butadiene layer to the metal surface and that the method of the present invention produces highly adhesive and strong film coverings on the surface of metal.

In tape testing experiments a tape with strongly adherent properties was applied to the surface of stainless steel samples coated by the method of the present invention as described in the example. The tape was then removed and both the tape and the coating on the samples were observed by optical microscopy (90×). No coating fragments were visible on the tape and the coating on the samples remained intact. These results demonstrate the high adhesive properties of the tie layer of the present invention on metal.

In solvent resistance studies stainless steel samples coated by the method of the present invention as described in the example were soaked in gently flowing methanol or hexane. In the case of the methanol soak the coating thickness before washing was 610 angstroms±20 angstroms and after washing 565 angstroms±20 angstroms. No coating damage or delamination was observed by optical microscopy (90×). In the case of the hexane soak the coating thickness before washing was 341 angstroms±20 angstroms and after washing 314 angstroms±20 angstroms. No coating damage or delamination was observed by optical microscopy (90×). The results of these studies indicate that the coating of the present invention is stably cross-linked and is not damaged by representative polar or nonpolar organic solvents.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, other metals besides stainless steel can by coated by the method of the present invention, including, for example, iron, nickel, chromium, copper, titanium, and metal alloys. Any kind of medical is prosthesis can be coated by the method of the present invention. The method of the present invention may be used with stents, guidewires, orthopedic joints, intraocular lenses, sutures, gauze pads, biosensors, and the like. Pharmacologic agents, such as, for example, heparin or antibiotics, can be delivered from secondary coatings attached to the tie layers of the present invention.

It will be understood that various changes in the details, materials, and arrangements of the parts which have been described and illustrated above in order to explain the nature of this invention may be made by those skilled in the art without departing from the principle and scope of the invention as recited in the following claims.

1. A method of forming a polymer tie layer on a metal surface, comprising the steps of:
1) cleaning said metal surface with solvent;
2) cleaning said metal surface with oxygen plasma;
3) sputter cleaning said metal surface with argon; and
4) functionalizing said metal surface and depositing said tie layer on said metal surface, said tie layer being deposited by radio frequency plasma deposition.

2. The method of claim 1 wherein said tie layer contains one or more C═C bonds or one or more C≡C bonds.

3. The method of claim 2 wherein said tie layer is a polymer composed of butadiene or acetylene.

4. The method of claim 1 wherein the step of sputter cleaning uses a lower chuck bias plasma generating unit.

5. The method of claim 1 wherein the step of functionalizing is produced by a plasma gas selected from the group consisting of O₂, NH₃, H₂O, CO₂, and H₂O₂.

6. The method of claim 1 wherein said tie layer is deposited under pulsed conditions of a duty cycle, where said duty cycle is reduced over time.

7. The method of claim 1 wherein said tie layer is a polymer that has lubricious properties or blood compatible properties or a combination thereof.

8. The method of claim 7 wherein said tie layer is deposited under pulsed conditions of a duty cycle, where said duty cycle is reduced over time.

9. The method of claim 8 wherein said metal is stainless steel.

10. The method of claim 1 wherein said the step of cleaning said metal surface comprises the use of methylene chloride, isopropanol, and deionized water.

11. The method of claim 6 wherein said tie layer is chemically bound to said metal surface.

12. The method of claim 11 wherein a second layer is chemically bound to said tie layer.

13. A method of forming a polymer tie layer on a metal surface, comprising the steps of:
1) cleaning said metal surface with methylene chloride, isopropanol, and deionized water;
2) cleaning said metal surface with oxygen plasma;
3) sputter cleaning said metal surface with argon; and
4) functionalizing said metal surface and depositing said tie layer on said metal surface, said tie layer being deposited by radio frequency plasma deposition under pulsed conditions of a duty cycle, where said duty cycle is reduced over time.

14. The method of claim 13 wherein said tie layer is selected from the group consisting of butadiene, acetylene, vinyl pyrrolidinone, derivitized silane, and acrylic acid.

15. The method of claim 14 wherein the step of sputter cleaning uses a lower chuck bias plasma generating unit.

16. A method of forming a butadiene polymer tie layer on a metal surface, comprising the steps of:
1) cleaning said metal surface with methylene chloride, isopropanol, and deionized water;
2) cleaning said metal surface with oxygen plasma;
3) sputter cleaning said metal surface with argon, wherein the step of sputter cleaning uses a lower chuck bias plasma generating unit; and
4) functionalizing said metal surface with O₂, NH₃, H₂O, CO₂, or H₂O₂, and depositing said tie layer on said metal surface by radio frequency plasma deposition under pulsed conditions of a duty cycle, where said duty cycle is reduced over time.

17. The method of claim 16 wherein said tie layer is selected from the group consisting of butadiene, acetylene, vinyl pyrrolidinone, derivitized silane, and acrylic acid.

18. The method of claim 17 wherein said metal is stainless steel.
